(19) United States
(12) Patent Application Publication
(10) Pub. No.: US 2025/0357047 A1
(43) Pub. Date: Nov. 20, 2025

(54) MULTILAYER CERAMIC ELECTRONIC COMPONENT AND METHOD OF MANUFACTURING THE SAME

(71) Applicant: TAIYO YUDEN CO., LTD., Tokyo (JP)

(72) Inventors: Katsunosuke HAGA, Tokyo (JP); Kenji SAITO, Tokyo (JP); Hiroaki UENISHI, Tokyo (JP); Satoshi KOBAYASHI, Tokyo (JP)

(73) Assignee: TAIYO YUDEN CO., LTD., Tokyo (JP)

(21) Appl. No.: 19/281,083

(22) Filed: Jul. 25, 2025

Related U.S. Application Data
(63) Continuation of application No. PCT/JP2023/045917, filed on Dec. 21, 2023.

(30) Foreign Application Priority Data
Feb. 9, 2023 (JP) 2023-018566

(51) Int. Cl. H01G 4/232; C04B 41/48; C04B 41/52; C09D 7/40; C09D 7/62; H01G 4/12; H01G 4/248; H01G 4/30; H01G 13/00

(52) U.S. Cl. CPC H01G 4/2325; C04B 41/48; C04B 41/52; C09D 7/62; C09D 7/69; H01G 4/12; H01G 4/248; H01G 4/30; H01G 13/006

(57) ABSTRACT

A multilayer ceramic electronic component includes a multilayer body that has a substantially rectangular parallelepiped shape and includes a plurality of internal electrode layers and a plurality of dielectric layers laminated on each other, the plurality of internal electrode layers being led out to a pair of end surfaces facing each other in a direction substantially orthogonal to a lamination direction of the plurality of internal electrode layers and the plurality of dielectric layers, and each of a pair of external electrodes that includes a base layer provided on one of the end surfaces so as to be connected to the internal electrode layers, a resin electrode layer provided on the base layer and containing a plurality of aluminum fillers coated with silvers, and a plating layer provided on the resin electrode layer.

### CROSS-REFERENCE TO RELATED APPLICATION

This continuation application is based upon and claims the benefit of priority of International Patent Application No. PCT/JP2023/045917, filed on Dec. 21, 2023, which claims the benefit of priority of Japanese Patent Application No. 2023-018566 filed on Feb. 9, 2023, the entire contents of which are incorporated herein by reference.

### FIELD

A certain aspect of the present disclosure relates to a multilayer ceramic electronic component and a method of manufacturing a multilayer ceramic electronic component.

### BACKGROUND

In recent years, with an increase in the number of in-vehicle electrical devices and in-vehicle semiconductors due to activation of safety equipment of automobiles and introduction of automatic driving technology, the number of multilayer ceramic capacitors mounted on these devices has increased. A conductive resin layer may be provided in an external electrode of a multilayer ceramic capacitor so as to exhibit flexibility against deflection of a circuit substrate on which the multilayer ceramic capacitor is mounted.

A large number of fillers defining an energization path are dispersed in the conductive resin layer. As the filler, for example, silver is used, but as described in Japanese Laid-Open Patent Publication No. 2022-93198, it is possible to reduce the cost by using a filler in which copper is coated with silver.

### SUMMARY OF THE INVENTION

According to a first aspect of the present disclosure, there is provided a multilayer ceramic electronic component including: a multilayer body that has a substantially rectangular parallelepiped shape and includes a plurality of internal electrode layers and a plurality of dielectric layers laminated on each other, the plurality of internal electrode layers being led out to a pair of end surfaces facing each other in a direction substantially orthogonal to a lamination direction of the plurality of internal electrode layers and the plurality of dielectric layers; and each of a pair of external electrodes that includes a base layer provided on one of the end surfaces so as to be connected to the internal electrode layers, a resin electrode layer provided on the base layer and containing a plurality of aluminum fillers coated with silvers, and a plating layer provided on the resin electrode layer.

According to a second aspect of the present disclosure, there is provided a method of manufacturing a multilayer ceramic electronic component, including: forming a multilayer body having a substantially rectangular parallelepiped shape and including a plurality of internal electrode layers and a plurality of dielectric layers laminated on each other, the plurality of internal electrode layers being alternately led out along a lamination direction to a pair of end surfaces facing each other; applying a conductive paste to one of the pair of end surfaces so as to be in contact with the internal electrode layers; applying a resin paste containing a plurality of aluminum fillers coated with silvers onto the conductive paste; and forming a plating layer on the resin paste.

### BRIEF DESCRIPTION OF THE DRAWINGS

FIG. 1 is a perspective view illustrating an example of a multilayer ceramic capacitor.

FIG. 2 is a cross-sectional view of the multilayer ceramic capacitor taken along a line A-A in FIG. 1.

FIG. 3 is a cross-sectional view of the multilayer ceramic capacitor taken along a line B-B in FIG. 1.

FIG. 4 is a cross-sectional view illustrating an example of a layer configuration of an external electrode.

FIG. 5 is a cross-sectional view illustrating an example of a resin electrode layer.

FIG. 6 is a flowchart illustrating an example of a manufacturing processes of a multilayer ceramic capacitor.

### DETAILED DESCRIPTION

However, with regard to the weight of the multilayer ceramic capacitor, it is difficult to achieve sufficient weight reduction with the filler described in Japanese Laid-Open Patent Publication No. 2022-93198 in consideration of the difference in density between copper and silver.

An object of the present disclosure is to provide a multilayer ceramic electronic component with reduced weight and a method of manufacturing a multilayer ceramic electronic component with reduced weight.

### Embodiment

### (Configuration of Multilayer Ceramic Capacitor)

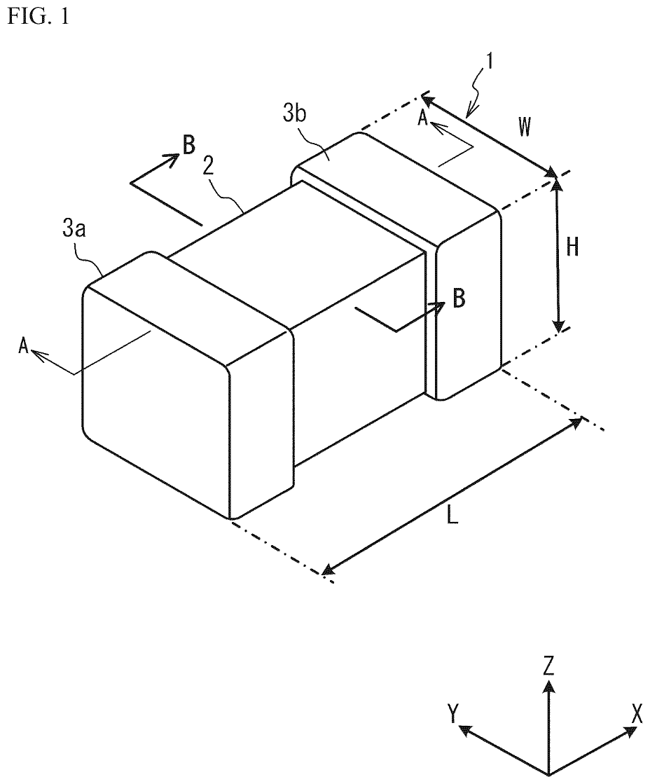

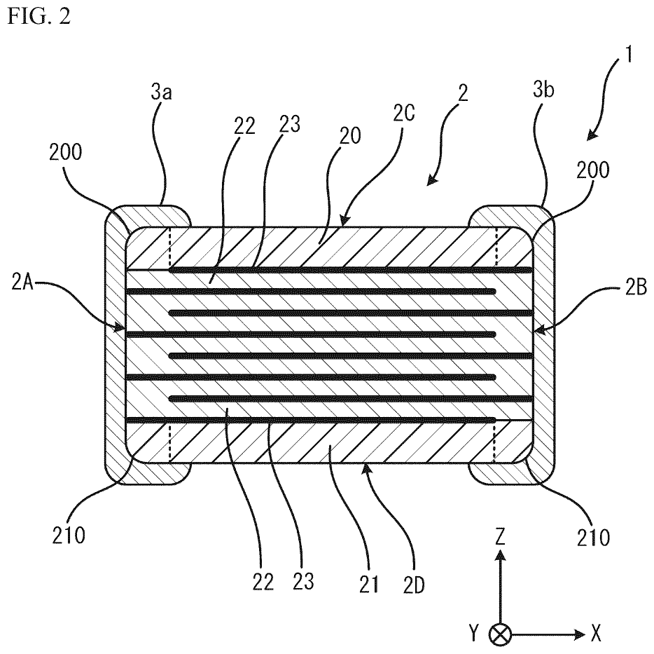

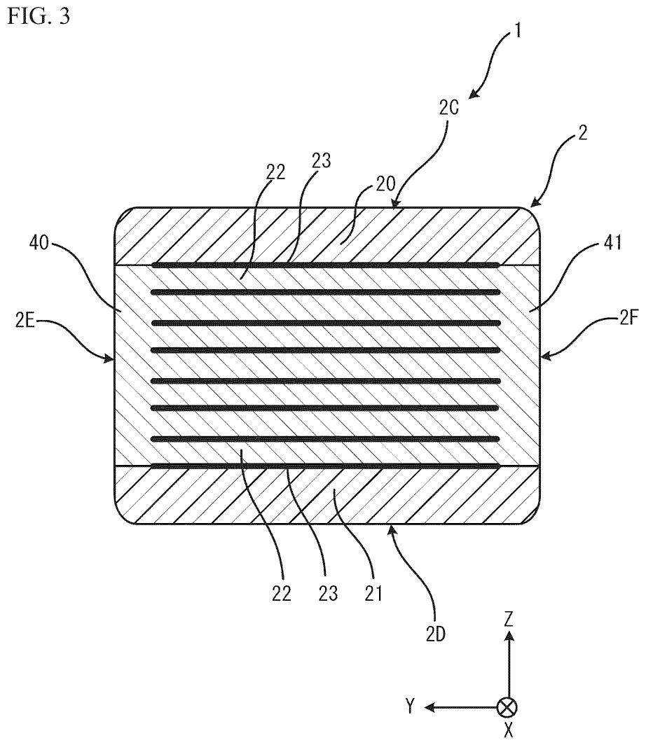

FIG. 1 is a perspective view illustrating an example of a multilayer ceramic capacitor 1. FIG. 2 is a cross-sectional view of the multilayer ceramic capacitor 1 taken along a line A-A in FIG. 1. FIG. 3 is a cross-sectional view of the multilayer ceramic capacitor 1 taken along a line B-B in FIG. 1.

The multilayer ceramic capacitor 1 is an example of a multilayer ceramic electronic component. Other examples of the multilayer ceramic electronic component include a multilayer ceramic varistor and a multilayer ceramic thermistor, and in the present embodiment, a multilayer ceramic capacitor is illustrated as a representative example thereof. The multilayer ceramic capacitor 1 includes a multilayer body 2 having a substantially rectangular parallelepiped shape, and external electrodes 3a and 3b provided on a pair of end surfaces 2A and 2B of the multilayer body 2 facing each other.

In FIGS. 1 to 3, an X direction, a Y direction, and a Z direction orthogonal to each other are illustrated. The X direction is a length (L) direction of the multilayer ceramic capacitor 1, and coincides with a direction in which the pair of end surfaces 2A and 2B of the multilayer body 2 face each other. The Y direction is a widthwise (W) direction of the multilayer ceramic capacitor 1, and coincides with a direction in which a pair of side surfaces 2E and 2F of the multilayer body 2 face each other. The Z direction is a height (H) direction of the multilayer ceramic capacitor 1 and coincides with a lamination direction of the multilayer ceramic capacitor 1. The X direction is an example of a direction substantially orthogonal to the lamination direction.

The multilayer body 2 includes an upper surface 2C, a lower surface 2D, the pair of end surface 2A and 2B, the pair of side surfaces 2E and 2F, and corner portions 200 and 210. The upper surface 2C and the lower surface 2D are substantially flat surfaces facing each other, the pair of end surface 2A and 2B are substantially flat surfaces facing each other, and the pair of side surfaces 2E and 2F are substantially flat surfaces facing each other.

The corner portions 200 and 210 are portions obtained by combining ridge portions of boundaries between the upper surface 2C, the lower surface 2D, the pair of end surfaces 2A and 2B, and the pair of side surfaces 2E and 2F, and top portions where the plurality of ridge portions are collected. The corner portions 200 are curved surface-shaped portions connecting the end surface 2A and the upper surface 2C adjacent to each other, and the end surface 2B and the upper surface 2C adjacent to each other. The corner portions 210 are curved surface-shaped portions connecting the end surface 2A and the lower surface 2D adjacent to each other, and the end surface 2B and the lower surface 2D adjacent to each other. The corner portions 200 are provided at both ends of the cover layer 20, and the corner portions 210 are provided at both ends of the cover layer 21. Note that the dotted lines indicate boundaries between the corner portions 200 each having a curved surface and the upper surface 2C having a substantially flat surface, and boundaries between the corner portions 210 each having a curved surface and the lower surface 2D having a substantially flat surface.

The multilayer body 2 has a multilayer structure in which dielectric layers 22 including a ceramic material functioning as a dielectric and internal electrode layers 23 are alternately laminated, and a pair of cover layers 20 and 21 are laminated so as to interpose the dielectric layers 22 and the internal electrode layers 23 therebetween from both sides in the lamination direction. A portion in which the dielectric layers 22 and the internal electrode layers 23 are alternately laminated may be referred to as a “capacitance portion layer”. The cover layers 20 and 21 interpose the capacitance portion layer therebetween from both sides in the lamination direction. Side margins 40 and 41 are provided on both sides of the internal electrode layers 23 and the dielectric layers 22 in the width direction. The side margins 40 and 41 interpose the capacitance portion layer therebetween from both sides in the width direction.

The internal electrode layers 23 are opposed to each other with the dielectric layers 22 interposed therebetween in the lamination direction, and one ends thereof are alternately led out to the end surfaces 2A and 2B along the lamination direction. The internal electrode layers 23 are composed of a base metal such as Ni (nickel), Cu (copper), or Sn (tin) as a main material. A noble metal such as Pt (platinum), Pd (palladium), Ag (silver), or Au (gold), or an alloy containing these may be used as the internal electrode layer 23. The thickness of the internal electrode layer 23 is, for example, 0.3 to 1.3 (μm). The thickness of the internal electrode layer 23 is not limited to this, and may be, for example, 0.3 (μm) or less, or 0.05 to 0.3 (μm). Further, the thickness of the internal electrode layer 23 may be 1.3 (μm) or more, or may be 1.3 to 3.5 (μm).

The dielectric layer 22 includes, for example, a ceramic material having a perovskite structure represented by a general formula ABO₃ as a main phase. The perovskite structure includes ABO_{3-α} (a represents a minute number) that deviates from the stoichiometric composition. For example, as the ceramic material, at least one of BaTiO₃ (barium titanate), CaZrO₃ (calcium zirconate), CaTiO₃ (calcium titanate), SrTiO₃ (strontium titanate), MgTiO₃ (magnesium titanate), and Ba_{1-x-y}CaₓSr_{y}Ti_{1-z}Zr₂O₃ (0≤x≤1, 0≤y≤1, 0≤z≤1) forming a perovskite structure can be selected and used. Ba_{1-x-y}CaₓSr_{y}Ti_{1-z}Zr₂O₃ is barium strontium titanate, barium calcium titanate, barium zirconate, barium zirconate titanate, calcium zirconate titanate, barium calcium zirconate titanate, and the like. The thickness of the dielectric layer 22 is, for example, 0.3 to 4.0 (μm). The thickness of the dielectric layer 22 is not limited to this, and may be 0.3 (μm) or less, or may be 0.05 to 0.3 (μm). Further, the thickness of the dielectric layer 22 may be 4.0 (μm) or more, or may be 4.0 to 20.0 (μm).

The cover layers 20 and 21 and the side margins 40 and 41 are also formed using a ceramic material as a main component, similarly to the dielectric layers 22.

The external electrodes 3a and 3b cover the end surfaces 2A and 2B of the multilayer body 2 facing each other in the length direction of the multilayer ceramic capacitor 1, respectively. The external electrodes 3a and 3b extend to the upper surface 2C, the lower surface 2D, and the side surfaces 2E and 2F. However, the external electrodes 3a and 3b are separated from each other on the surfaces of the upper surface 2C, the lower surface 2D, and the side surfaces 2E and 2F. The external electrodes 3a and 3b have the following layer structure, for example.

### (Layer Configuration of External Electrode)

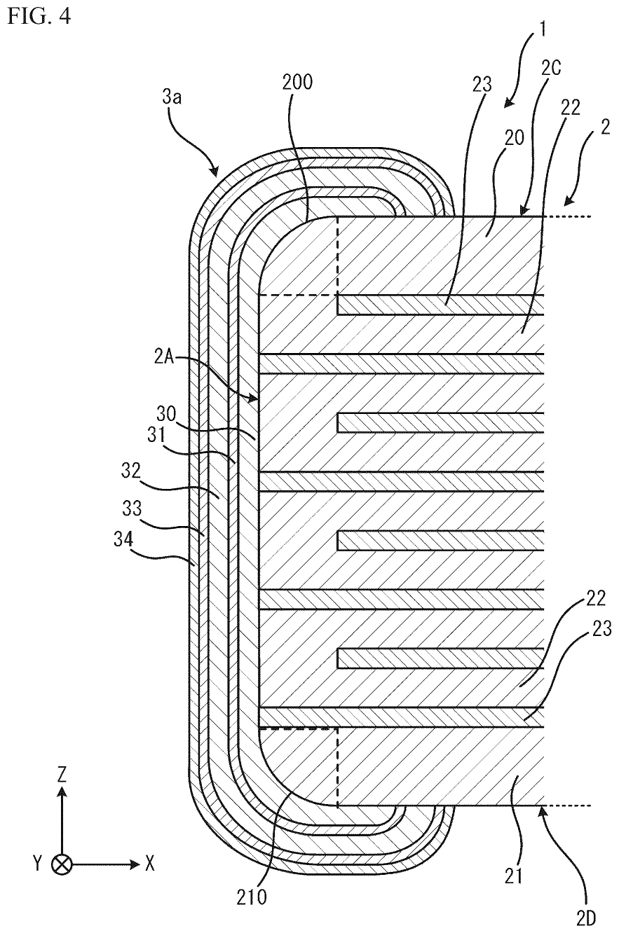

FIG. 4 is a cross-sectional view illustrating an example of a layer configuration of the external electrode 3a. FIG. 4 illustrates the cross-sectional view of the multilayer body 2 along a direction substantially perpendicular to the end surface 2A and the upper surface 2C and the lower surface 2D adjacent to the end surface 2A. In FIG. 4, the same reference numerals are given to the same components as those in FIG. 2, and the description thereof will be omitted. Although only one external electrode 3a is illustrated in FIG. 4, the other external electrode 3b has the same configuration as the external electrode 3a.

The external electrode 3a include a base layer 30, an internal plating layer 31, a resin electrode layer 32, and two external plating layers 33 and 34. The base layer 30, the internal plating layer 31, the resin electrode layer 32, and the external plating layer 33 and 34 are laminated in an order from closest to farthest from the multilayer body 2.

The base layer 30 covers the end surface 2A so as to be electrically connected to the internal electrode layers 23. The base layer 30 contains a metal such as Cu, Ni, Al (aluminum), or Zn (zinc) as a main component, and contains a glass component for densifying the base layer 30 and a co-fired material for controlling the sinterability of the base layer 30. The base layer 30 has good adhesion to the dielectric layer 22 and the cover layers 20 and 21, which are composed of a ceramic material as a main component.

The internal plating layer 31 covers the base layer 30. The internal plating layer 31 is formed by a plating treatment with a metal such as Cu.

The resin electrode layer 32 covers the internal plating layer 31. The resin electrode layer 32 is a conductive resin layer containing a metal component. Examples of the resin include thermosetting resins such as epoxy resins, but the resin is not limited thereto. The resin electrode layer 32 relaxes stress caused by deflection of a circuit substrate on which the multilayer ceramic capacitor 1 is mounted, by flexibility of the resin.

The external plating layer 33 covers the resin electrode layer 32. The external plating layer 33 is formed by a plating treatment with a metal such as Ni. The external plating layer 34 covers the external plating layer 33. The external plating layer 34 is formed by a plating treatment with a metal such as Sn. Each of the external plating layers 33 and 34 is an example of a plating layer provided on the resin electrode layer 32.

### (Configuration of Resin Electrode Layer)

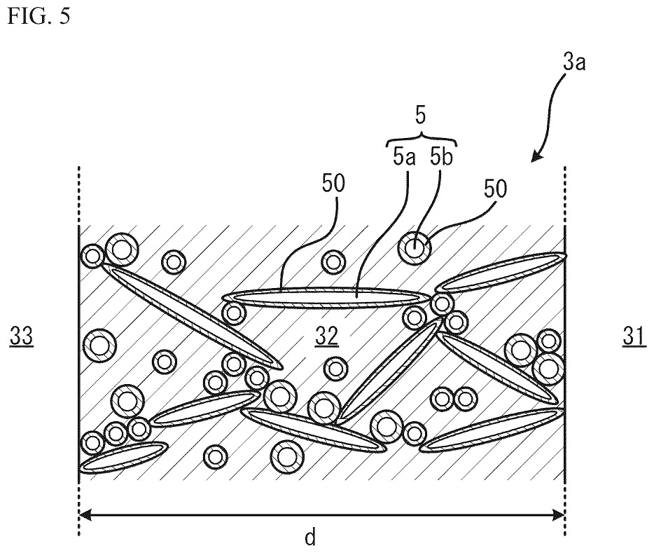

FIG. 5 is a cross-sectional view illustrating an example of the resin electrode layer 32. FIG. 5 illustrates an enlarged view of the resin electrode layer 32 illustrated in FIG. 4.

A large number of aluminum fillers 5 are dispersed in the resin electrode layer 32. The aluminum fillers 5 contain both flat-shaped fillers 5a and spherical fillers 5b. The aluminum filler 5 has a silver coating film 50. That is, the aluminum filler 5 is an aluminum particle whose surface is coated with silver. The sizes of the flat-shaped filler 5a and the spherical filler 5b in FIG. 5 are illustrated at a ratio different from the actual ratio for the sake of simplicity.

The aluminum fillers 5 are in contact with each other, and thus the energization path is formed between the internal plating layer 31 and the external plating layer 33 adjacent to the resin electrode layer 32. At this time, the aluminum filler 5 has the silver coating film 50, and therefore can exhibit high conductivity.

The specific gravity of aluminum is smaller than that of copper. Therefore, the mass of the resin electrode layer 32 containing the aluminum filler 5 is smaller than the mass of a resin electrode layer of the same volume containing the same number of copper fillers. Therefore, the weight of the multilayer ceramic capacitor 1 can be reduced. In particular, the larger the size of the multilayer ceramic capacitor 1, the larger the volume of the resin electrode layer 32, and thus the more significant the effect of weight reduction.

In addition, since aluminum is generally less expensive than copper, the use of the resin electrode layer 32 containing the aluminum filler 5 can reduce the cost of the multilayer ceramic capacitor 1 as compared with the case of using a resin electrode layer containing a copper filler.

On the other hand, the electrical conductivity (hereinafter referred to as conductivity) of aluminum is smaller than the conductivity of copper. However, the conductivity can be increased by adjusting the coverage of silver coating the aluminum filler 5. The coverage is, for example, a ratio of the surface area of the silver coating film 50 to the surface area of the aluminum particle, and is calculated as the length of the outer periphery of the aluminum particle coated with the silver coating film 50 to the length of the entire outer periphery of the aluminum particle in the cross section as illustrated in FIG. 5. The cross section of the multilayer ceramic capacitor 1 can be observed with, for example, a scanning electron microscope (SEM).

The average value of the coverage factor of silver coating each aluminum filler 5 in the resin electrode layer 32 is preferably 80(%) or more because the conductivity is effectively increased. More preferably, the average value of the coverage of silver may be 90(%) or more. It is preferable that the coverage of the silver coating film 50 is large from the viewpoint of suppressing an increase in equivalent series resistance (ESR) due to oxidation of the aluminum filler 5.

In addition, when the coverage of silver is excessively large, the cost of the multilayer ceramic capacitor 1 may excessively increase. Therefore, the average value of the coverage factor of silver coating each aluminum filler 5 in the resin electrode layer 32 is preferably 99(%) or less. More preferably, the average value of the coverage of silver may be 95(%) or less.

The conductivity can be improved not only by the above method but also by adjusting the thickness of the silver coating film 50. The average thickness of the silver coating the aluminum fillers 5 in the resin electrode layer 32 is preferably 10 (nm) or more because the conductivity is effectively increased. More preferably, the average value of the thickness of the silver may be 90 (nm) or more. In addition, from the viewpoint of suppressing an increase in the series equivalent resistance due to oxidation of the aluminum filler 5, the film thickness of the silver coating film 50 is preferably large.

In addition, when the film thickness of the silver coating film 50 is excessively large, the cost of the multilayer ceramic capacitor 1 may excessively increase. Therefore, the average value of the thickness of silver is preferably 500 (nm) or less. More preferably, the average value of the thickness of silver may be 100 (nm) or less.

The conductivity can be improved not only by the above method but also by adjusting the content of the aluminum filler 5 in the resin electrode layer 32. The content is calculated from the ratio of the total mass of the aluminum fillers 5 to the mass of the entire resin electrode layer 32. The content of the aluminum filler 5 is preferably 40 (vol %) or more because the conductivity is effectively increased. More preferably, the content of aluminum filler 5 may be 46 (vol %) or more.

In addition, when the content of the aluminum filler 5 is excessively large, the adhesion strength between the resin electrode layer 32 and the base layer 30 is reduced, and there is a concern that the resin electrode layer 32 and the base layer 30 may be peeled off from each other due to heat during reflow. Therefore, the content of the aluminum filler 5 is preferably 70 (wt %) or less. More preferably, the content of the aluminum filler 5 may be 60 (Wt %) or less.

The average particle size of the aluminum filler 5 is preferably 1 (μm) or more because the aluminum filler 5 is less likely to settle when the aluminum filler 5, a resin, a solvent, and the like are contained in a paste for forming the resin electrode layer 32. More preferably, the average value of the particle diameters of the aluminum filler 5 may be 2 (μm) or more.

In addition, with regard to the spherical filler 5b, when the particle diameter of the aluminum filler 5 is excessively large, the number of the aluminum fillers 5 in the resin electrode layer 32 is decreased, and thus, the energization path is not formed well, and sufficient conductivity may not be obtained. Therefore, the average value of the particle diameters of the aluminum filler 5 is preferably 20 (μm) or less. The size of the flat-shaped filler 5a is preferably about several times to several tens of times the size of the spherical filler 5b.

A thickness “d” of the resin electrode layer 32 is preferably 10 (μm) or more so as to suppress peeling due to heat during reflow. More preferably, the thickness “d” of the resin electrode layer 32 may be 30 (μm) or more. On the other hand, when the thickness “d” of the resin electrode layer 32 is excessively large, the resistance component may increase to deteriorate the ESR, and the size of the multilayer body 2 may be reduced in accordance with the increase in the thickness of the resin electrode layer 32 to reduce the capacitance. Therefore, the thickness “d” of the resin electrode layer 32 is preferably 50 (μm) or less. Here, the thickness “d” is an average value of the thickness of the resin electrode layer 32 in a cross-sectional view along the lamination direction and the length direction of the multilayer ceramic capacitor 1 as illustrated in FIG. 4.

### (Method of Manufacturing Multilayer Ceramic Capacitor)

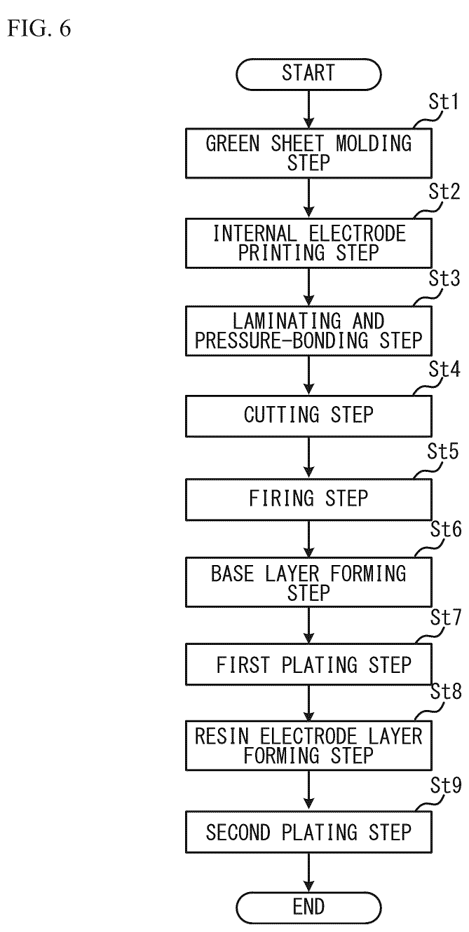

FIG. 6 is a flowchart illustrating an example of a manufacturing process of the multilayer ceramic capacitor 1. This manufacturing process is an example of a method of manufacturing a multilayer ceramic electronic component.

### (Green Sheet Molding Step)

First, a green sheet molding step St1 is performed. In this step, for example, a binder such as a polyvinyl butyral (PVB) resin, an organic solvent such as ethanol or toluene, and a plasticizer are added to a dielectric material obtained by adding various additive compounds (sintering aid, and so on) to a ceramic powder, and the mixture is wet-mixed. The obtained slurry is used to coat a dielectric green sheet on a base material by, for example, a die coater method or a doctor blade method, and the dielectric green sheet is dried. The base material is, for example, a PET (polyethylene terephthalate) film.

Mg (magnesium), Mn (manganese), V (vanadium), Cr (chromium), oxides of rare earth elements (Y (yttrium), Sm (samarium), Eu (europium), Gd (gadolinium), Tb (terbium), Dy (dysprosium), Ho (holmium), Er (erbium), Tm (thulium), and Yb (ytterbium)), and oxides of Co (cobalt), Ni, Li (lithium), B (boron), Na (sodium), K (potassium), and Si (silicon) or glass is used as the additive compound of the ceramic powder.

### (Internal Electrode Printing Step)

Next, an internal electrode printing step St2 is performed. In this step, the internal electrode patterns are formed by applying a conductive paste containing ceramic particles to the surfaces of the plurality of dielectric green sheets. The internal electrode pattern has a shape corresponding to the internal electrode layer.

In this step, the conductive paste containing a metal for forming internal electrode containing an organic binder is printed on the dielectric green sheet on the base material by gravure printing or the like, thereby forming the plurality of internal electrode patterns spaced apart from each other. The ceramic particles are added to the conductive paste as a co-fired material. The main component of the ceramic particles is not particularly limited, but is preferably the same as the main component ceramic of the dielectric layer 22.

### (Laminating and Pressure-Bonding Step)

Next, a laminating and pressure-bonding process St3 is performed. In this step, a plurality of dielectric green sheets on which internal electrode patterns to be the internal electrode layers 23 are printed are laminated and pressure-bonded to form a multilayer sheet. At the time of pressure-bonding, the dielectric green sheets are laminated so that the internal electrode patterns face each other with the dielectric green sheet interposed therebetween. The plurality of laminated dielectric green sheets are pressed to pressure-bond the dielectric green sheets to each other. The pressure-bonding means may be, for example, a hydrostatic press, but is not limited thereto.

### (Cutting Step)

Next, a cut process St4 is performed. In this step, the multilayer sheet obtained by the pressure-bonding is divided into a plurality of multilayer bodies each having a substantially rectangular parallelepiped shape. For example, a plurality of unfired multilayer bodies are obtained by cutting the multilayer sheet in the lamination direction along predetermined cut lines with a blade.

In this manner, the unfired multilayer body 2 is formed. The processes from the green sheet forming step St1 to the cutting step St4 are an example of a step of forming the multilayer body 2.

### (Firing Step)

Next, a firing step St5 is performed. In this step, the multilayer body is subjected to a binder removal treatment in a N₂ atmosphere at 250 to 500° C., and then fired at a firing temperature of 1200° C. or higher for about 1 hour in a reduction atmosphere with a partial pressure of oxygen of 0.003 (Pa), whereby the particles in the multilayer body are sintered. As a result, in the multilayer body, the dielectric green sheets become the cover layers 20 and 21, the side margins 40 and 41, and the dielectric layers 22, and the internal electrode patterns become the internal electrode layers 23.

Next, the external electrodes 3a and 3b are formed. The external electrodes 3a and 3b may be fired simultaneously with the multilayer body 2.

### (Base Layer Forming Step)

First, a base layer forming step St6 is performed. In this step, a conductive paste containing a glass frit, a binder, and a solvent is applied to the multilayer body 2 by, for example, a dipping method. The conductive paste is applied to the end surfaces 2A and 2B, the side surfaces 2E and 2F, both ends of the upper surface 2C in the length direction, and both ends of the lower surface 2D in the length direction of the multilayer body 2. At this time, the conductive paste is in contact with the internal electrode layers 23 led to the end surfaces 2A and 2B. After the application, the conductive paste is dried and fired to form the base layer 30. The binder and the solvent are volatilized by firing.

### (First Plating Step)

Next, a first plating step St7 is performed. In this step, the internal plating layer 31 is formed so as to cover the base layer 30 by, for example, an electrolytic plating method.

### (Resin Electrode Layer Forming Step)

Next, a resin electrode layer forming step St8 is performed. In this step, a resin paste containing the plurality of aluminum fillers 5 coated with silvers is applied onto the base layer 30 and the internal plating layer 31. Examples of the resin paste include thermosetting resins such as epoxy resins, but the resin paste is not limited thereto. Since the aluminum filler 5 has a specific gravity smaller than that of the copper filler, the settling velocity of the aluminum filler 5 in the resin paste is suppressed more than in the case of the copper filler. Especially in the case of the flat-shaped filler 5a, the settling velocity is effectively suppressed. Therefore, the deviation of the distribution of the aluminum filler 5 in the resin paste is reduced. After the application, the resin paste is cured by heat treatment to form the resin electrode layer 32.

### (Second Plating Step)

Next, a second plating step St9 is performed. In this step, the external plating layers 33 and 34 are formed so as to cover the resin electrode layer 32 by, for example, an electrolytic plating method. The multilayer ceramic capacitor 1 is manufactured in this manner.

The above embodiments are merely examples for carrying out the present disclosure, and the present disclosure is not limited to these embodiments. It is to be understood that the various change, substitutions, and alterations could be made hereto without departing from the spirit and scope of the invention.

What is claimed is:

1. A multilayer ceramic electronic component comprising:
a multilayer body that has a substantially rectangular parallelepiped shape and includes a plurality of internal electrode layers and a plurality of dielectric layers laminated on each other, the plurality of internal electrode layers being led out to a pair of end surfaces facing each other in a direction substantially orthogonal to a lamination direction of the plurality of internal electrode layers and the plurality of dielectric layers; and
each of a pair of external electrodes that includes a base layer provided on one of the end surfaces so as to be connected to the internal electrode layers, a resin electrode layer provided on the base layer and containing a plurality of aluminum fillers coated with silvers, and a plating layer provided on the resin electrode layer.

2. The multilayer ceramic electronic component according to claim 1, wherein
an average value of coverage factors of the silvers coating the plurality of aluminum fillers is 80% or more.

3. The multilayer ceramic electronic component according to claim 1, wherein
an average value of coverage factors of the silvers coating the plurality of aluminum fillers is 99% or less.

4. The multilayer ceramic electronic component according to claim 1, wherein
an average value of thicknesses of the silvers coating the plurality of aluminum fillers is 10 nm or more.

5. The multilayer ceramic electronic component according to claim 1, wherein
an average value of thicknesses of the silvers coating the plurality of aluminum fillers is 500 nm or less.

6. The multilayer ceramic electronic component according to claim 1, wherein
a content of the plurality of aluminum fillers is 40 vol % or more.

7. The multilayer ceramic electronic component according to claim 1, wherein
a content of the plurality of aluminum fillers is 70 vol % or less.

8. The multilayer ceramic electronic component according to claim 1, wherein
an average value of particle diameters of the plurality of aluminum fillers is 1 μm or more.

9. The multilayer ceramic electronic component according to claim 1, wherein
an average value of particle diameters of the plurality of aluminum fillers is 20 μm or less.

10. The multilayer ceramic electronic component according to claim 1, wherein
an average value of thickness of the resin electrode layer is 10 μm or more.

11. The multilayer ceramic electronic component according to claim 1, wherein
an average value of thickness of the resin electrode layer is 50 μm or less.

12. A method of manufacturing a multilayer ceramic electronic component, comprising:
forming a multilayer body having a substantially rectangular parallelepiped shape and including a plurality of internal electrode layers and a plurality of dielectric layers laminated on each other, the plurality of internal electrode layers being alternately led out along a lamination direction to a pair of end surfaces facing each other;
applying a conductive paste to one of the pair of end surfaces so as to be in contact with the internal electrode layers;
applying a resin paste containing a plurality of aluminum fillers coated with silvers onto the conductive paste; and
forming a plating layer on the resin paste.
